(19) United States
(12) Patent Application Publication
(10) Pub. No.: US 2002/0055286 A1
(43) Pub. Date: May 9, 2002

(54) MULTIPLE TWIST RECEPTACLE PIN AND THE CONNECTOR USING THE SAME

(76) Inventors: ALAN R. MACDOUGALL, PALM BEACH, FL (US); HOWARD OU, TAIPEI (TW)

Correspondence Address: WEI TE JOSEPH CHUNG, FOXCONN INTERNATIONAL INC, 1650 MEMOREX DRIVE, SANTA CLARA, CA, 95050

(21) Appl. No.: 09/300,174

(22) Filed: Apr. 27, 1999

(51) Int. Cl. H01R 4/66

(52) U.S. Cl. 439/108

(57) ABSTRACT

A multiple twist receptacle contact comprises a compliant conductor portion substantially extending along a vertical direction for forcible engaging within a plated hole of an external printed circuit board. An intermediate portion is connected to the compliant conductor portion. A contacting portion comprises a relatively wide plate from which a pair of resilient arms extends and each resilient arm has a first twist section connected to a second twist section, wherein the first twist section is twisted with respect to an axis of the resilient arm a first angle and the second twist section is twisted with respect to the axis of the resilient arm a second angle.

### BACKGROUND OF THE INVENTION

1. Field of The Invention

The present invention relates to a receptacle pin, especially a multiple twist receptacle pin and the connector using the same which is used together with a complementary connector and together constitute a future bus connector assembly.

2. The Prior Art

Future bus connectors have been used in electrical connection between a backplane and several daughter boards. Normally, a modular plug connector is connected to the backplane and a complementary receptacle connector is connected to the daughter board. A plurality of receptacle pins are retained in the receptacle connector for receiving pins extending from the plug connector thereby electrically connecting the daughter board to the backplane. U.S. Pat. No. 5,066,236 has disclosed a receptacle connector having a plurality of right angle receptacle pins shown in FIG. 8 thereof each of which has a single twisted point in the mating portion thereof for forming the mating portion to have a relatively large contacting area with the inserted plug pin. The single twisted point is twisted by substantially 90 degrees from an intermediate section of the contact in order to change the wider portion thereof from a vertical direction to a horizontal direction so as to cooperate with another opposite mating portion to receive the inserted plug pin. However, this mating portion is apt to cause crack therein due to the large angle of twist (substantially 90 degrees) thereby negatively affect the performance of the contact such as causing extra impedance or unreliable impedance or causing some of the mating portions to be biased from a true horizontal direction. Since the future bus usually functions in a high frequency environment, the unreliable impedance will cause unwanted reflection of signal thereby attenuating the signal transmission. If some of the mating portions are deflected from a true horizontal direction, the insertion of the plug pin may be blocked by the latter thereby negatively affecting the mechanical engagement between the two connectors. Moreover, the deflected mating portions will cause different contacting resistances between different pairs of plug pin and receptacle pins thereby causing mismatching problem in the impedance. Accordingly, it is requisite to provide a new receptacle contact which can eliminate the drawback of the prior art.

### SUMMARY OF THE INVENTION

The primary purpose of the present invention is to provide an improved receptacle pin used in a future bus for providing reliable impedance.

In accordance with one aspect of the present invention, a multiple twist receptacle contact comprises a compliant conductor portion substantially extending along a vertical direction for forcible engaging within a plated hole of an external printed circuit board. An intermediate portion is connected to the compliant conductor portion. A contacting portion comprises a relatively wide plate from which a pair of resilient arms extend and each resilient arm has a first twist section connected to a second twist section, wherein the first twist section is twisted with respect to an axis of the resilient arm a first angle and the second twist section is twisted with respect to the axis of the resilient arm a second angle.

### BRIEF DESCRIPTION OF THE DRAWINGS

FIG. 1 is a perspective view of several multiple twist receptacle contacts in accordance with the present invention;

FIG. 2 is perspective view showing the contacts of FIG. 1 being received in a web;

FIG. 3 is an enlarged view showing a portion of the contact of FIG. 1;

FIG. 4 is an assembled view of the web of FIG. 2 and to an insulative housing of a connector in accordance with the present invention; and

FIG. 5 is a partially cross-sectional view taken from lines 5-5 of FIG. 4.

### DETAILED DESCRIPTION OF THE PREFERRED EMBODIMENT

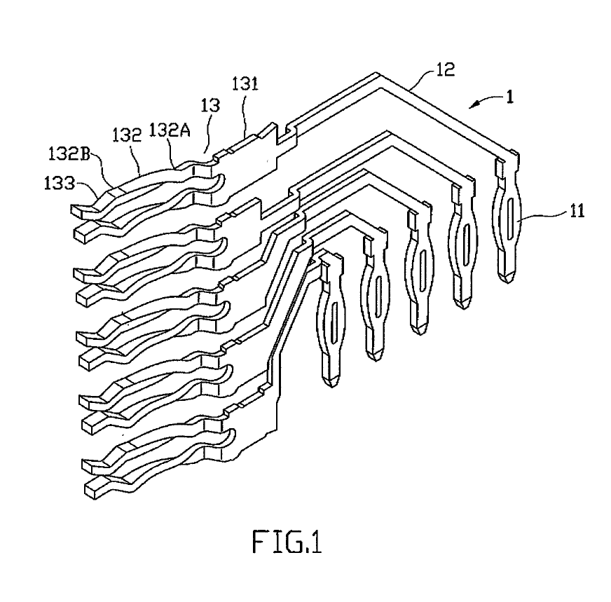

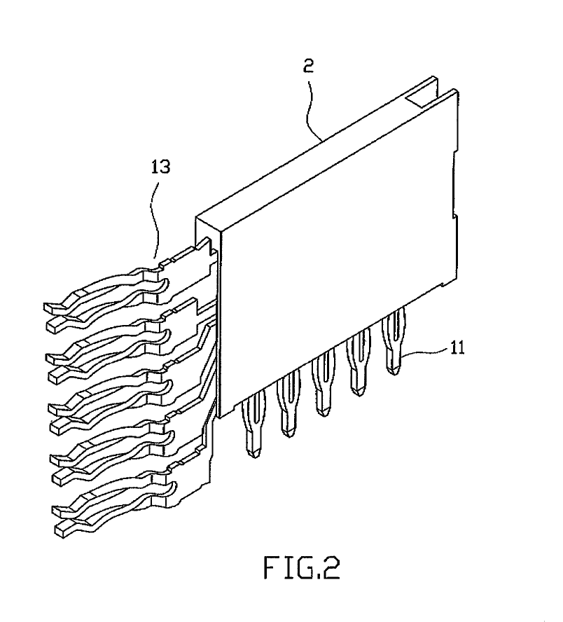

Referring to FIGS. 1 and 2, a row of multiple twist receptacle contacts 1 in accordance with the present invention each comprise a compliant conductor portion 11, an intermediate portion 12 extending from the compliant conductor portion 11 and retained in a web 2 by insert molding, and a mating portion 13 extending from the intermediate portion 12 while not received in the web 2. The mating portion 13 is substantially coplanar with and perpendicular to the compliant conductor portion 11 though not directly connected thereto. The row of contacts 1 each have identical compliant conductor portions 11 and mating portions 13 and similar intermediate portions 12 with different lengths. The mating portion 13 has a flat plate section 131 which is wider than the intermediate portion 12 and a pair of resilient arms 132 extending from the flat plate section 131, wherein each resilient arm 132 has a width several times larger than the thickness thereof.

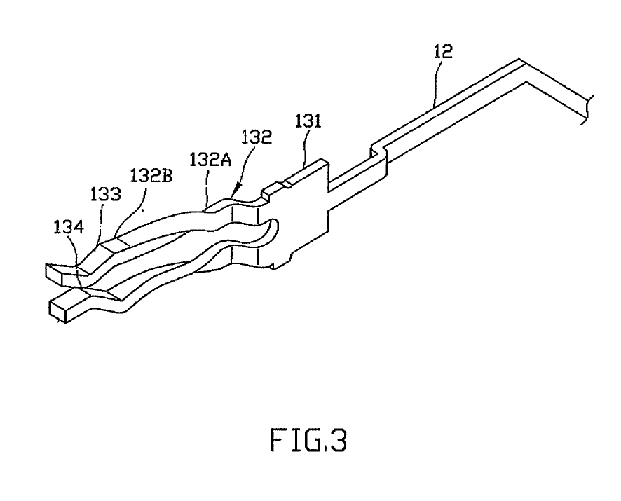

Also referring to FIG. 3, each resilient arm 132 has a first twist section 132A substantially twisted a first angle such as 60 degrees with respect to an axis thereof and a second twist section 132B distanced from the first twist section 132A and twisted a second angle such as 30 degrees with respect to the axis of the resilient arm 132. In manufacturing, the second twist section 132B is twisted earlier than the first twist section 132A. The multiple twist sections 132A, 132B together twist about 90 degrees with respect to the axis of the resilient arm 132 other than a single-point twist of 90 degrees thereby preventing from crack thereof. It should be noted that the first angle and the second angle are not limited to the above mentioned. The first angle may be greater than, less than, or identical to the second angle. A contacting section 133 is connected to the second twist section 132B and has an angled portion 134 formed in a middle portion thereof.

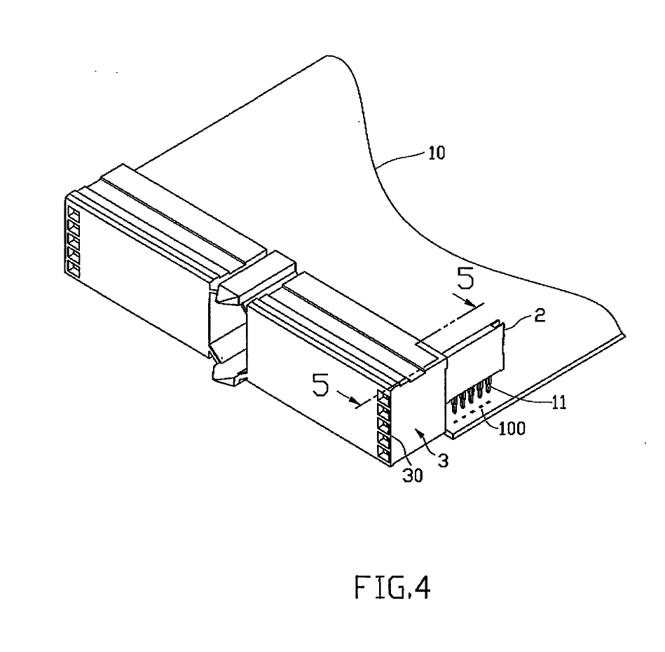

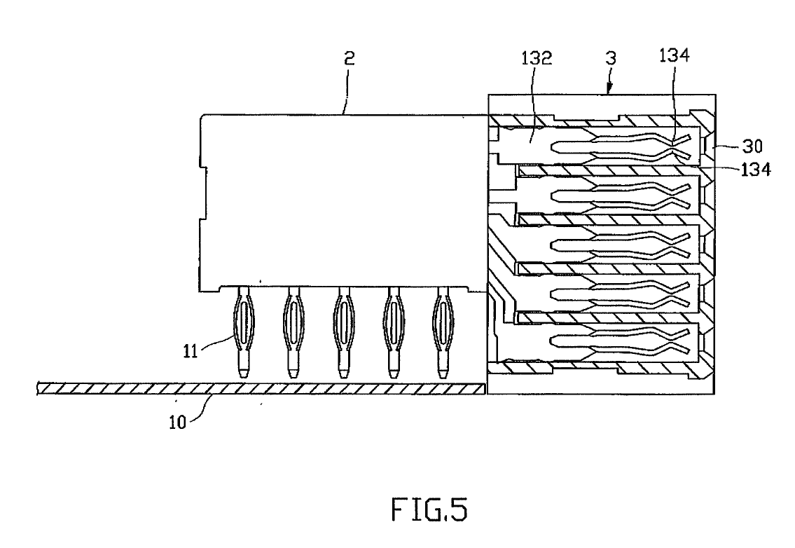

Referring to FIGS. 4 and 5, the web 2 containing the contacts is engaged with an insulative housing 3 by inserting the contacting portion 13 of each contact into corresponding passageway 30 of the housing 3. After several webs 2 are engaged with the housing 3, the compliant conductor portions 11 of the contacts 1 are forcedly inserted within a plated hole 100 of a printed circuit board 10. The angled portions 134 of the pair of resilient arms 132 face to each other for contacting with an inserted plug pin of a complementary connector (not shown) which is inserted into the passageway 30 of the housing 3. The pair of resilient arms 132 are deformed outward from each other when the angled portions 134 thereof are impacted by the inserted plug pin. The multiple twist sections 132A, 132B of the resilient arm 132, compared to the conventional single-point twist section of the resilient arm, can also effectively prevent crack thereof during frequent insertion/withdrawal of the external plug pin thereby guaranteeing a reliable impedance of the receptacle contact 1.

While the present invention has been described with reference to a specific embodiment, the description is illustrative of the invention and is not to be construed as limiting the invention. Therefore, various modifications to the present invention can be made to the preferred embodiment by those skilled in the art without departing from the true spirit and scope of the invention as defined by the appended claims.

What is claimed is:

1. A multiple twist receptacle contact comprising:
a compliant conductor portion substantially extending along a vertical direction for forcible engaging within a plated hole of an external printed circuit board;
an intermediate portion connected to the compliant conductor portion;
a contacting portion comprising a relatively wide plate from which a pair of resilient arms extends and each resilient arm has a first twist section connected to a second twist section, wherein the first twist section is twisted with respect to an axis of the resilient arm at a first angle and the second twist section is twisted with respect to the axis of the resilient arm at a second angle.

2. The multiple twist receptacle contact as claimed in claim 1, wherein the first angle is greater than the second angle.

3. The multiple twist receptacle contact as claimed in claim 1, wherein the first angle is identical to the second angle.

4. The multiple twist receptacle contact as claimed in claim 1, wherein the first angle is less than the second angle.

5. The multiple twist receptacle contact as claimed in claim 2, wherein the sum of the first angle and the second angle are ninety degrees.

6. The multiple twist receptacle contact as claimed in claim 3, wherein the sum of the first angle and the second angle are ninety degrees.

7. The multiple twist receptacle contact as claimed in claim 4, wherein the sum of the first angle and the second angle are ninety degrees.

8. The multiple twist receptacle contact as claimed in claim 1, wherein the compliant conductor portion is substantially perpendicular to the axis of the resilient arm.

9. The multiple twist receptacle contact as claimed in claim 1, wherein each resilient arm has a contacting section connected to the second twist section and the contacting section has an angled portion formed in a middle portion thereof so that the angled portions in each pair of resilient arms face to each other.

10. An electrical connector comprises an insulative housing defines rows of passageways and a plurality of webs each containing a plurality of contacts partially retained therein and partially extending out from adjacent sides of the webs, wherein each of the contacts comprises a compliant conductor portion substantially extending along a vertical direction out of the web for forcible engaging within a plated hole of an external printed circuit board, an intermediate portion connected to the compliant conductor portion and retained in the web, and a contacting portion extending out of the web along a horizontal direction and received in a corresponding passageway of the housing, the contacting portion comprising a relatively wide plate from which a pair of resilient arms extends and each resilient arm has a first twist section connected to a second twist section, and wherein the first twist section is twisted with respect to an axis of the resilient arm a first angle and the second twist section is twisted with respect to the axis of the resilient arm a second angle.

11. The electrical connector as claimed in claim 10, wherein the first angle of the first twist section of the resilient arm is greater than the second angle of the second twist section of the resilient arm.

12. The electrical connector as claimed in claim 10, wherein the first angle of the first twist section of the resilient arm is less than the second angle of the second twist section of the resilient arm.

13. The electrical connector as claimed in claim 10, wherein the first angle of the first twist section of the resilient arm is identical to the second angle of the second twist section of the resilient arm.

14. The electrical connector as claimed in claim 11, wherein the sum of the first angle and the second angle are ninety degrees.

15. The electrical connector as claimed in claim 12, wherein the sum of the first angle and the second angle are ninety degrees.

16. The electrical connector as claimed in claim 13, wherein the sum of the first angle and the second angle are ninety degrees.

17. The electrical connector as claimed in claim 10, wherein each resilient arm of the contact has a contacting section connected to the second twist section and the contacting section has an angled portion formed in a middle portion thereof so that the angled portions in each pair of resilient arms face to each other.

18. A multiple twist receptacle contact comprising:
a conductor portion for engagement with an external device;
an intermediate portion connected to said compliant conductor portion; and
a contacting portion connected to said intermediate portion and comprising a pair of resilient arms; wherein each of said resilient arms includes a plurality of twist sections spaced from one another with a relatively significant distance and a sum of twisted angles performed by the respective twist sections is generally 90 degrees.
